(19) United States
(12) Patent Application Publication
(10) Pub. No.: US 2006/0151098 A1
(43) Pub. Date: Jul. 13, 2006

(54) System and method for making self-adhesive durable labels

(76) Inventor: Aaron David Rutsky, Canton, CT (US)

Correspondence Address: CANTOR COLBURN, LLP, 55 GRIFFIN ROAD SOUTH, BLOOMFIELD, CT, 06002, US

(21) Appl. No.: 11/304,322

(22) Filed: Dec. 14, 2005

Related U.S. Application Data
(60) Provisional application No. 60/636,380, filed on Dec. 14, 2004.

(51) Int. Cl. B32B 7/06; B32B 7/12; B32B 37/00

(52) U.S. Cl. 156/253; 428/40.1; 428/41.7

(57) ABSTRACT

Disclosed is a system for making self-adhesive durable labels including a sheet including a receiver portion and a cover portion, at least one mark receiver included at the receiver portion, and at least one protective cover included at the cover portion, wherein the at least one protective cover is disposed on the cover portion of said sheet to at least partially associate with the at least one mark receiver via a configuring of the sheet.

### CROSS-REFERENCE TO RELATED APPLICATION

This application claims benefit of priority to provisional application U.S. 60/636,380, which is hereby incorporated by reference in its entirety:

### FIELD OF THE INVENTION

This disclosure relates generally to a system for producing labels, and more particularly to a system for producing self-adhesive durable labels.

### BACKGROUND OF THE INVENTION

In an ever more globalized world, shipping of packages large and small continues to grow. As it is desirable to have packages reach the intended recipient, shipping labels are of course used. The nature of shipping necessitates that such shipping labels be adhesive and weather resistant, so they may withstand the rough treatment that packages endure during shipping, such as getting wet, ripped, and/or being defaced or smudged. Weather resistant, adhesive shipping labels are currently available, but they are usually pre-printed and laminated by a manufacturer. Pre-printed, laminated labels are weather resistant, but they can generally not be further marked or written on, and thus allocate little flexibility in label message (address, recipient, etc.).

Labels may also be weather proofed by a user following label marking by the user, but the process of weather proofing these labels involves application of a protective laminate that is separate from the label and sheet that contains the label. This process likely involves manual application of the laminate, which must be properly sized (and thus cut or supplied in various sizes) and aligned with a label in order to be applied and protect. Manually, sizing and aligning the laminates can be tedious and difficult, leading to mismatched laminates that may be wrinkled or otherwise poorly applied, reducing label protection. Thus, a more convenient and precise labeling system is needed.

### BRIEF DESCRIPTION OF THE INVENTION

Disclosed is a system for making self-adhesive durable labels including a sheet including a receiver portion and a cover portion, at least one mark receiver included at the receiver portion, and at least one protective cover included at the cover portion, wherein the at least one protective cover is disposed on the cover portion of said sheet to at least partially associate with the at least one mark receiver via a configuring of the sheet.

Also disclosed is a method for making self-adhesive durable label systems, including disposing at least one mark receiver on a receiver portion of a sheet, and disposing at least one protective cover on a cover portion of the sheet, with the at least one protective cover and the at least one mark receiver being positioned on the sheet to be associated upon a configuration of the sheet.

Further disclosed is a method for making self-adhesive durable label systems, disposing at least one protective cover on a cover portion of a sheet, disposing at least one adhesive guard on the at least one protective cover, disposing at least one mark receiver on a receiver portion of the sheet, with the at least one protective cover and the at least one mark receiver being positioned on the sheet to be associated upon a configuration of the sheet, and perforating the sheet to facilitate the configuration of said sheet.

### BRIEF DESCRIPTION OF THE FIGURES

The foregoing and other features and advantages of the present invention should be more fully understood from the following detailed description of illustrative embodiments taken in conjuncture with the accompanying Figures in which like elements are numbered alike in the several Figures:

FIG. 1 is a top perspective view of a receiver side of a system for making self-adhesive durable labels in accordance with an exemplary embodiment;

FIG. 2 is a top perspective view of a cover side of the system for making self-adhesive durable labels in accordance with the exemplary embodiment;

FIG. 3 is a top perspective view of a marked receiver side of the system for making self-adhesive durable labels in accordance with the exemplary embodiment;

FIG. 4 is a top perspective view of a cover side of the system for making self-adhesive durable labels in accordance with the exemplary embodiment, wherein the at least one adhesive guard is removed;

FIG. 5 is a side perspective view of the system for making self-adhesive durable labels in accordance with the exemplary embodiment;

FIG. 6 is a top perspective view a configured system for making self-adhesive durable labels in accordance with the exemplary embodiment;

FIG. 7 is a side perspective view the configured system for making self-adhesive durable labels in accordance with the exemplary embodiment;

FIG. 8 is a side perspective view a protected label in accordance with the exemplary embodiment;

FIG. 9 is a top perspective view the protected label in accordance with the exemplary embodiment;

FIG. 10 is a block diagram illustrating a method for making self-adhesive durable label systems; and

FIG. 11 is a block diagram illustrating a second method for making self-adhesive durable label systems.

### DETAILED DESCRIPTION OF THE INVENTION

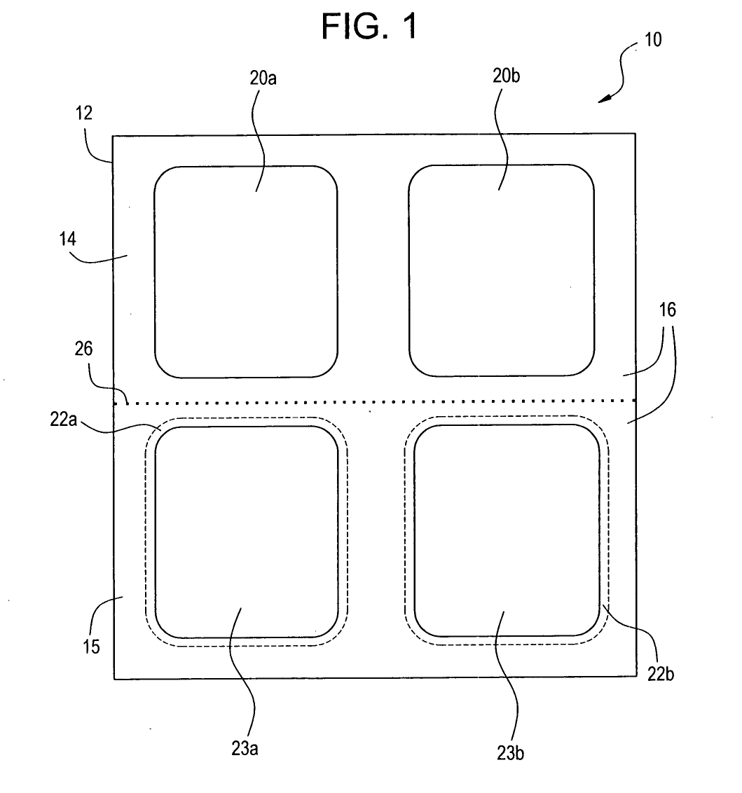

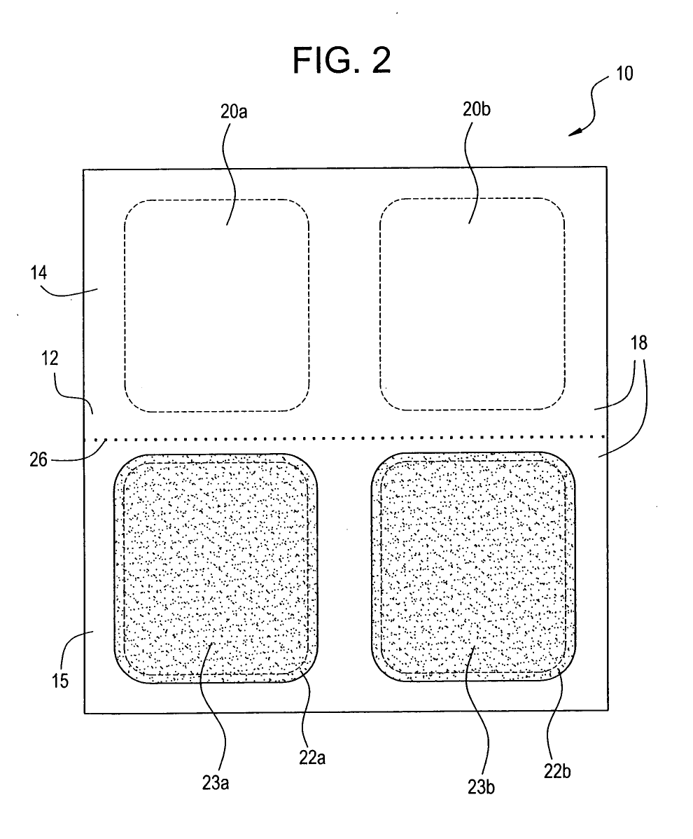

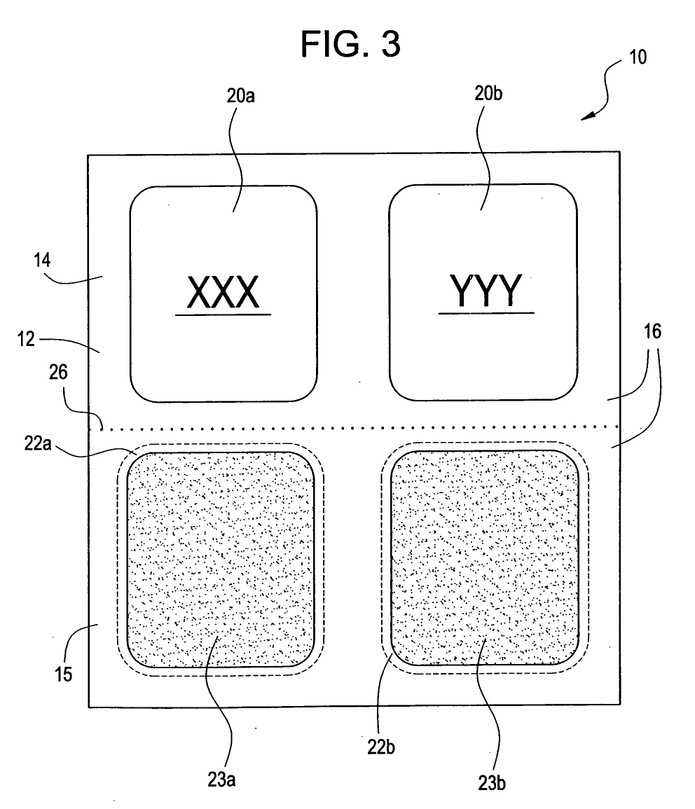

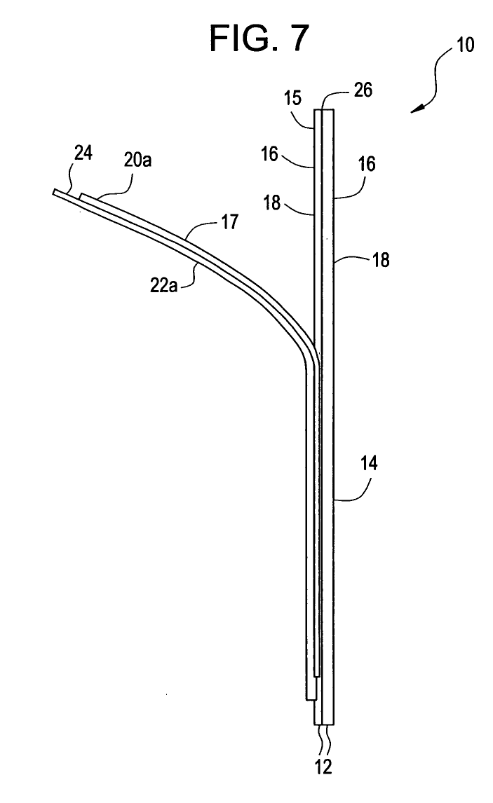

Referring to FIG. 1 and FIG. 2, an exemplary embodiment of a system 10 for making self-adhesive durable labels is illustrated, and includes a sheet 12 including a receiver portion 14 and a cover portion 15. The sheet 12 also includes a receiver side 16 (face up in FIG. 1, face down in FIG. 2) and a cover side 18 (face up in FIG. 2, face down in FIG. 1). At least one mark receiver, illustrated as receivers 20a and 20b, is included at the receiver portion 14 of the sheet 12, in adherence with the receiver side 16 via a receiver adhesive portion (illustrated for the first time at 17 in FIG. 7). At least one protective cover, illustrated as covers 22a and 22b, is included at the cover portion 15 of the sheet 12, in adherence with the cover side 18, wherein at least one protective cover is constructed of a protective material which allows perception of images residing behind it. Additionally, a cover adhesive portion (illustrated for the first time at 24 in FIG. 3) of each of the covers 22a and 22b is protected by at least one adhesive guard disposed on the receiver side 16 of the cover portion 15, and illustrated as guards 23a and 23b. The at least one protective cover 22a and 22b is disposed or positioned on the cover portion 15 of the sheet 12 so as to at least partially associate with the at least one receiver 20a and 20b via a configuring of the sheet 12.

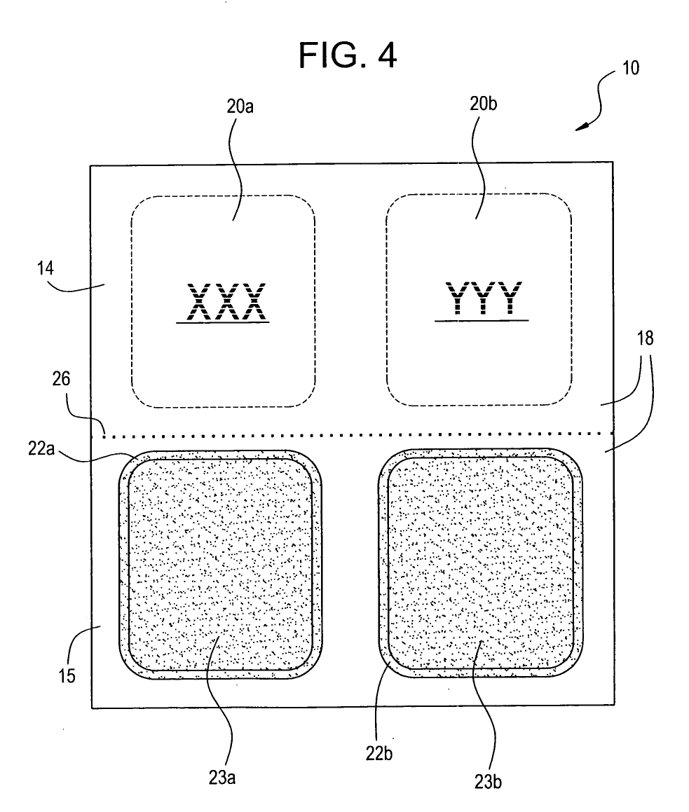

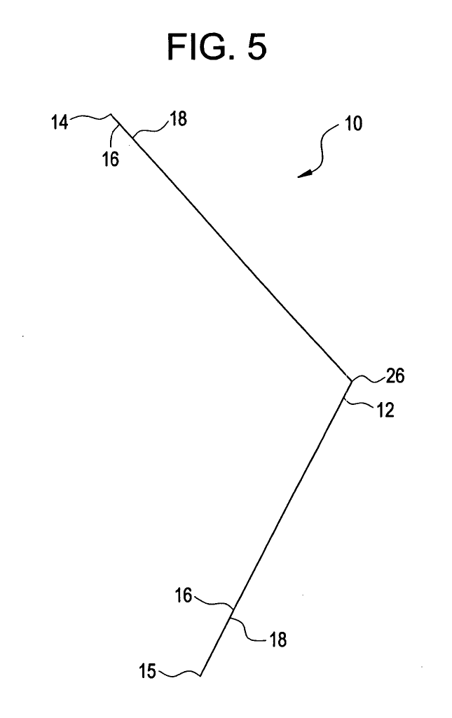

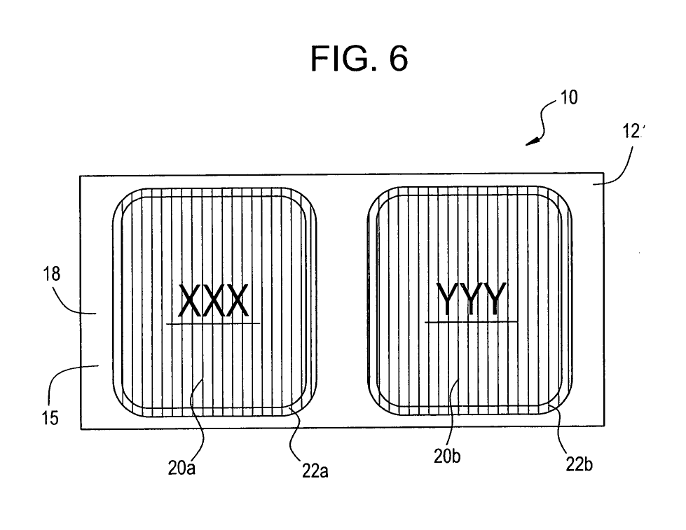

Referring to FIG. 3, FIG. 4, and FIG. 5, after marking at least one of the receivers 20a and 20b with marks XXX and YYY, the sheet is configured by removing at least one of the guards 23a and 23b from association with the cover adhesive portion 24 (briefly introduced above) of at least one of the covers 22a and 22b, and folding the sheet 12 along a predetermined folding region, such as a perforated edge 26. The folding occurs as shown in FIG. 5, resulting in a sheet 12 configuration as shown in FIG. 6.

Referring to FIG. 5 and FIG. 6, the sheet 12 is folded in a manner that allows the receiver side 16 of the receiver portion 14 to contact the receiver side 16 of the cover portion 15. This further allows the receivers 20a and 20b to at least partially associate with the cover adhesive portions 24 (exposed upon removal of the guards 23a and 23b as shown in FIG. 3) of the covers 22a and 22b, wherein the covers 22a and 22b will at least partially cover the portions of the receivers 20a and 20b that include the marks XXX and YYY. Because the covers 22a and 22b allow perception of images residing behind them, it will be possible to continue to perceive the marks XXX and YYY through the covers 22a and 22b that are now associated with the receivers 20a and 20b. It should be appreciated that FIG. 6 is illustrated to show the cover side 18 of the cover portion 15 of the sheet 12 facing upwardly/outwardly from the page.

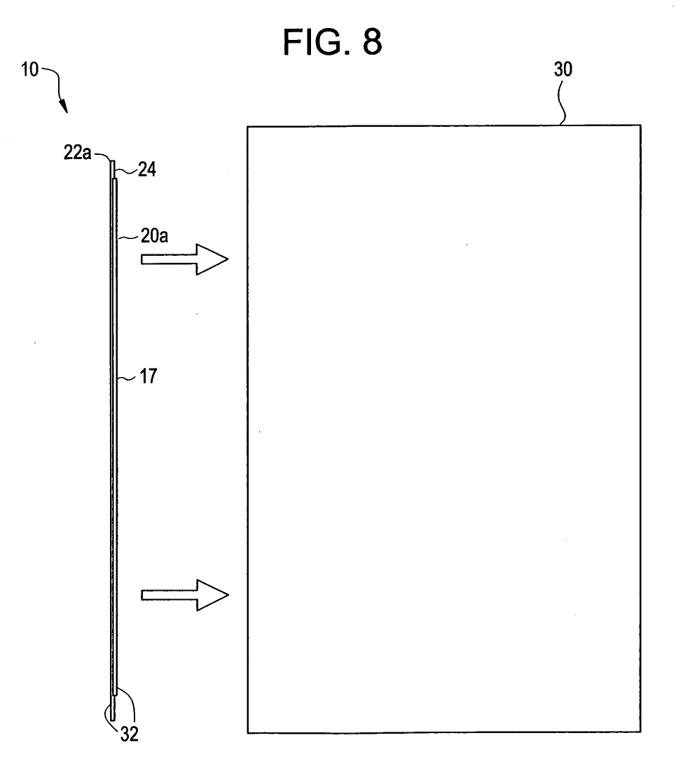

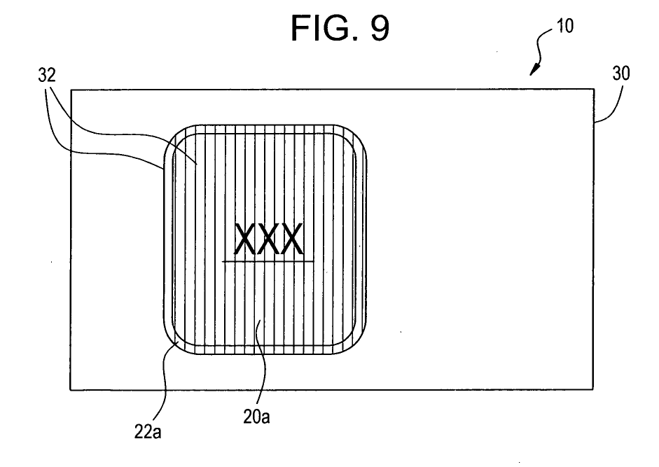

Referring to FIG. 7, the cover 22a is shown in association with the receiver 20a via the cover adhesive portion 24, wherein the cover adhesive portion 24 of the cover 22a is being pulled away from association with the cover side 18 of the cover portion 15, while the receiver adhesive portion 17 (briefly introduced above) of the receiver 20a is pulled away from association with the folded over receiver side 16 of the receiver portion 14. Referring to FIG. 8, the associated cover 22a and receiver 20a are ultimately removed completely from the sheet 12, exposing the cover adhesive portion 17 and a part of the cover adhesive portion 24 not associating with the receiver 20a. The receiver adhesive portion 17 and the part of the cover adhesive portion 24 not associating with the receiver 20a are then allowed to associate the receiver 20a and cover 22a with a package 30, labeling that package 30 with a protected label 32 as shown in FIG. 9.

It should be appreciated that the sheet 12 may extend in one or more directions to facilitate at least one additional configuration, wherein the at least one additional configuration allows additional, at least partial associations of the at least one protective cover and the at least one mark receiver. It should also be appreciated that the sheet 12 may be associated with at least one additional sheet. The additional sheet may include an additional receiver portion, an additional cover portion, at least one additional mark receiver included at the additional receiver portion, and at least one additional protective cover included at the additional cover portion, wherein the at least one additional protective cover is disposed on the additional cover portion of the at least one additional sheet to at least partially associate with the at least one additional mark receiver via a configuring of the at least one additional sheet. The sheet 12 (including sheets that extend in one or more directions to facilitate at least one additional configuration), and/or the at least one additional sheet associated with the sheet 12, may be disposed into rolled form (i.e. rolled up) or at least partially disposed onto a roll supporting structure to facilitate multiple configurations of the sheet 12 and/or at least one additional sheet, wherein in each configuration may produce at least one (though likely multiple) protected labels 32. Furthermore, the sheet 12 (extended or not) and or at least one additional sheet may be configured linearly or axially by the roll supporting structure (which may be actuated) or any device, mechanism, or structure associated with the rolled sheets or roll supporting structure, in order to produce at least one protected label 32.

It should be further appreciated that the sheet 12 may produce protected labels 32 for every mark receiver included with that sheet 12, and that marks may be present on the at least one mark receiver 20a and 20b before reaching a label user (i.e., the at least one mark receiver 20a and 20b may be at least partially marked by a system 10 manufacturer). Additionally, a protected label 32 may be affixed to any type of package, envelope, and/or item that may require protection, such as book labels, bar codes, and inspection stickers that may be exposed to wet or damp environments. It should still further be appreciated that the at least one protective cover 22a and 22b is at least one of water resistant, ultraviolet light resistant, and abrasion resistant.

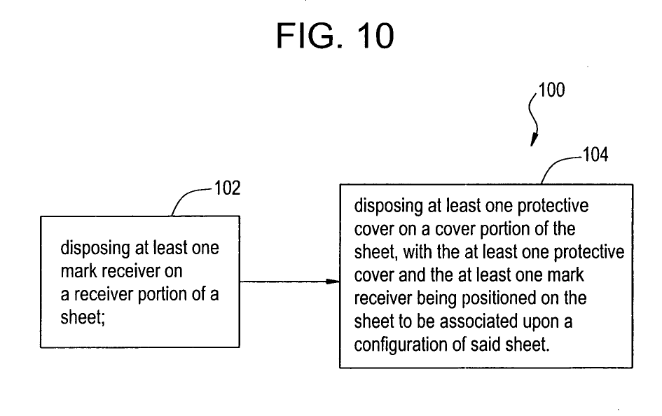

Referring to FIG. 10, a method 100 for making self-adhesive durable label systems is illustrated and includes disposing at least one mark receiver 20a and 20b on a receiver portion 14 of a sheet 12, as shown in Operational Block 102. The method 100 also includes disposing at least one protective cover 22a and 22b on a cover portion 15 of the sheet 12, with the at least one protective cover 22a and 22b and the at least one mark receiver 20a and 20b being positioned on the sheet 12 to be associated upon a configuration of said sheet 12, as shown in Operational Block 104. The method 100 may further include disposing the at least one protective cover 22a and 22b on the sheet 12 via a cover adhesive portion 24, and disposing the at least one mark receiver 20a and 20b on the sheet 12 via a receiver adhesive portion 17.

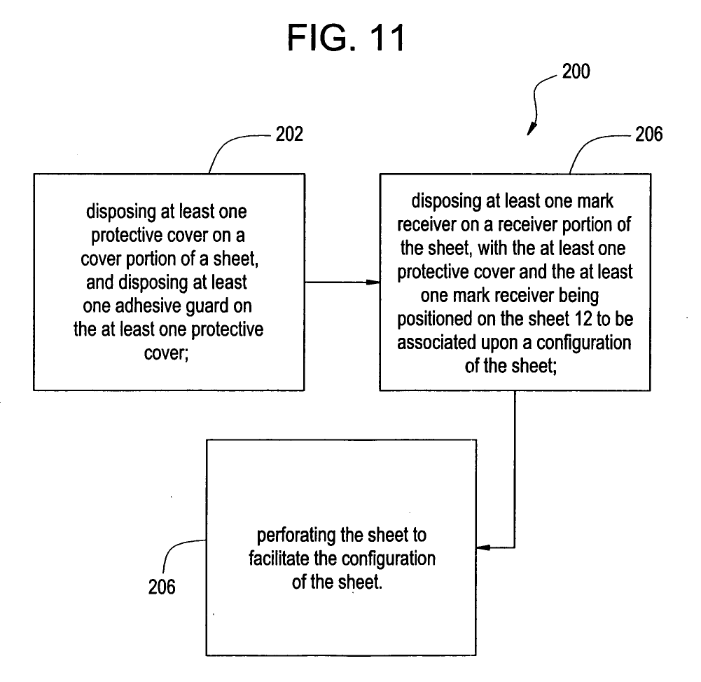

Referring to FIG. 11, a method 200 for making self-adhesive durable label systems is illustrated and includes disposing at least one protective cover 22a and 22b on a cover portion 15 of a sheet 12, and disposing at least one adhesive guard 23a and 23b on the at least one protective cover 22a and 22b, as shown in Operational Block 202. The method 200 also includes disposing at least one mark receiver 20a and 20b on a receiver portion 14 of the sheet 12, with the at least one protective cover 22a and 22b and the at least one mark receiver 20a and 20b being positioned on the sheet 12 to be associated upon a configuration of the sheet 12, as shown in Operational Block 204. The method 200 further includes perforating the sheet 12 to facilitate the configuration of the sheet 12, as shown in Operational Block 206.

The method 200 may additionally include disposing the at least one protective cover 22a and 22b on the sheet 12 via a cover adhesive portion 24, and disposing the at least one mark receiver 20a and 20b on the sheet 12 via a receiver adhesive portion 17. The method 200 may further include disposing the at least one adhesive guard 23a and 23b on the at least one protective cover 22a and 22b via the cover adhesive portion 17.

While the invention has been described with reference to an exemplary embodiment, it should be understood by those skilled in the art that various changes may be made and equivalents may be substituted for elements thereof without departing from the scope of the invention. In addition, many modifications may be made to adapt a particular situation or substance to the teachings of the invention without departing from the scope thereof. Therefore, it is important that the invention not be limited to the particular embodiment disclosed as the best mode contemplated for carrying out this invention, but that the invention will include all embodiments falling within the scope of the apportioned claims. Moreover, unless specifically stated any use of the terms first, second, etc. do not denote any order or importance, but rather the terms first, second, etc. are used to distinguish one element from another.

What is claimed is:

1. A system for making self-adhesive durable labels, the system comprising:
a sheet including a receiver portion and a cover portion;
at least one mark receiver included at said receiver portion; and
at least one protective cover included at said cover portion, wherein said at least one protective cover is disposed on said cover portion of said sheet to at least partially associate with said at least one mark receiver via a configuring of said sheet.

2. A system according to claim 1, wherein said configuring of said sheet is a folding of said sheet along a predetermined folding region.

3. A system according to claim 2, wherein said predetermined folding region is a perforated edge.

4. A system according to claim 1, wherein said at least one mark receiver includes a receiver adhesive portion.

5. A system according to claim 1, wherein at least one adhesive guard is associated with said at said least one protective cover.

6. A system according to claim 5, wherein said at least one adhesive guard is associated with said at least one protective cover via a cover adhesive portion.

7. A system according to claim 1, wherein said at least one protective cover at least partially associates with said at least one mark receiver via a cover adhesive portion.

8. A system according to claim 1, wherein said at least one protective cover is at least one of water resistant, ultraviolet light resistant, and abrasion resistant.

9. A system according to claim 1, wherein said sheet extends in one or more directions to facilitate at least one additional configuration, wherein said at least one additional configuration allows additional, at least partial associations of said at least one protective cover and said at least one mark receiver.

10. A system according to claim 1, wherein said sheet is associated with at least one additional sheet that includes an additional receiver portion, an additional cover portion, at least one additional mark receiver included at said additional receiver portion, and at least one additional protective cover included at said additional cover portion, wherein said at least one additional protective cover is disposed on said additional cover portion of said at least one additional sheet to at least partially associate with said at least one additional mark receiver via a configuring of said at least one additional sheet.

11. A system according to claim 10, wherein said sheet and said at least one additional sheet are disposed into rolled form.

12. A system according to claim 10, wherein said sheet and said at least one additional sheet are disposed onto roll supporting structure

13. A method for making self-adhesive durable label systems, the method comprising:
disposing at least one mark receiver on a receiver portion of a sheet; and
disposing at least one protective cover on a cover portion of said sheet, said at least one protective cover and said at least one mark receiver being positioned on said sheet to be associated upon a configuration of said sheet.

14. A method according to claim 13, further including disposing said at least one protective cover on said sheet via a cover adhesive portion, and disposing said at least one mark receiver on said sheet via a receiver adhesive portion.

15. A method for making self-adhesive durable label systems, the method comprising:
disposing at least one protective cover on a cover portion of a sheet;
disposing at least one adhesive guard on said at least one protective cover;
disposing at least one mark receiver on a receiver portion of said sheet, said at least one protective cover and said at least one mark receiver being positioned on said sheet to be associated upon a configuration of said sheet; and
perforating said sheet to facilitate said configuration of said sheet.

16. A method according to claim 15, further including disposing said at least one protective cover on said sheet via a cover adhesive portion, and disposing said at least one mark receiver on said sheet via a receiver adhesive portion.

17. A method according to claim 15, further including disposing said at least one adhesive guard on said at least one protective cover via said cover adhesive portion.
